(19) United States
(12) Patent Application Publication
(10) Pub. No.: US 2021/0161102 A1
(43) Pub. Date: Jun. 3, 2021

(54) PETGUARD

(71) Applicant: Easy on Pets, Cincinnati, OH (US)

(72) Inventor: Bhargav Madabhushi Rajamannar, Cincinnati, OH (US)

(73) Assignee: Easy on Pets, Cincinnati, OH (US)

(21) Appl. No.: 17/106,512

(22) Filed: Nov. 30, 2020

Related U.S. Application Data
(60) Provisional application No. 62/941,911, filed on Nov. 29, 2019.

(51) Int. Cl. A01K 15/04

(52) U.S. Cl. CPC A01K 15/04

(57) ABSTRACT

A pet guard device has a plurality of layers of movable elements. The movable elements are arranged in a telescoping manner. An activation mechanism is coupled to the layers of movable elements and is configured to move the layers of movable elements between a retracted state and an expanded state. A triggering device, when activated, is configured to cause the activation device to move the layers of movable elements to the expanded state. An attempt by the pet to move its head in either direction activates pressure points along the neck collar causing the telescopic mechanism to be activated, effectively creating a muzzle along the pet's jaw. The muzzle effectively creates a barrier between the pet's mouth and the bodily area intended to be avoided.

### FIELD

The aspects of the disclosed embodiments relate to pet head and facial guards, such as Elizabethan pet collars used to keep animals from accessing their own body in areas that are injured and/or post-surgical areas. In particular, the aspects of the disclosed embodiments are directed to protective devices for animals that will keep the animal's mouth from reaching certain parts of the animal's body thereby preventing the animal from inflicting further injury on themselves.

### BACKGROUND

Following a pet's surgery, typically veterinarians use some form of access restricting collars on pets. These cone style devices are commonly referred to as Elizabethan Collars. Shaped like a truncated cone, a pet cone's purpose is to prevent the animal from being able to bite or lick at its body or scratching at its head or neck while wounds or injuries heal.

In order to prevent the animal from irritating a wound or removing stitches while self-grooming, Elizabethan collars are used to either prevent the animal from licking/biting its wound or using its limbs to scratch their head or ears. The collar can also be used to restrain animals with self-destructing habits, either from poor training or mental illness.

In addition to medicine such as ointments and pills, Elizabethan collars are necessary when dealing with an animal that is suffering from an allergy reaction. The main reasons are to prevent the animal from ingesting any of the medicine being applied on the skin, or to prevent it from harming itself in the infected area. The cone is configured to keep the animal from being able to reach the affected areas with its mouth.

The existing set of products serving this purpose are either stiff, or bulky and conspicuously extend out from the pet's body, i.e. occupy a large radial space around the pet's head/neck area. In addition, some of the products are made of heavy plastic that can cause discomfort from the weight. Furthermore, the opaque or translucent materials used can restrict the visibility of the pet, creating the additional need for increased clearances around the house. Thick plastic tabs that are supposed to be belted by the pet's collar at the base of the cone also end up gouging the neck of the pet thereby causing further or additional injury.

A number of alternative pet collars have been developed. However, they suffer from the same drawbacks as listed above in terms of being uncomfortable for the pet and bulky in appearance.

The collar of Miller (U.S. Pat. No. 4,476,814) comprises a self-supporting solid resilient foam body having a doughnut shape formed by a peripheral, generally annular wall defining a central opening adapted to fit around the neck of an animal such as a pet. The wall is wide enough to prevent a pet wearing it from mouthing a part of the pet's body and thus injuring itself by pulling stitches, licking wounds, etc. The body wall has a pair of spaced opposite ends bridged by a drawstring anchored to one of the ends and passing through the other end to the outside of the body, against which it is releasably locked by a spring clamp or the like.

The restraint collar of Lippincott (U.S. Pat. No. 5,133,295) is a veterinary restraint collar for a cat, comprising two side-by-side rings of soft, flexible and non-resilient medical padding material sewn together along their inner margins and having a drawstring passage with a “stretch” gauze drawstring in the passage. The rings have adjacent faces of thin plastic sheet material, and opposite faces of soft absorbent material, and are gathered to form radial pleats. The rings stand out from the neck hole to form a flexible barrier restricting the animal's ability to reach portions of its body with its mouth.

Accordingly, it would be desirable to provide an apparatus that addresses at least some of the problems described above.

### SUMMARY

The aspects of the disclosed embodiments are directed to a protective pet wear device includes a telescopic jaw guard that forms a snug cup along the jaw.

In a possible implementation form, the jaw cover itself is attached to a soft collar material along the neck, which effectively holds the telescopic pet guard in place.

In a possible implementation form, an attempt by the pet to move its head in a direction such as side to side or front to back is configured to activate pressure points along the neck collar causing the telescopic mechanism to be activated, effectively creating a muzzle along the pet's jaw. The muzzle effectively creates a barrier between the pet's mouth and the bodily area intended to be avoided.

In a possible implementation form, the collar is further held in place by an additional belt that is attached to the body, to prevent the collar itself from shifting around.

In a possible implementation form, a pet head motion restrictor includes a collar, and a collar mechanism that controls the transcoping action of a muzzle like extension. A transcoping mechanism for the purposes of this document is defined as an unfolding and/or extending mechanism, similar to an accordion mechanism.

In a possible implementation form, a muzzle like extension restricts the head of the pet from reaching the injured/surgical areas, so as to prevent the pet from licking, or hurting itself further post a surgical situation

In a possible implementation form, a belt holds the collar in place.

In a possible implementation form, there is a pressure activated muzzle transcoping mechanism, that can go from a retracted to extended state.

In a possible implementation form, a pressure activated muzzle transcoping mechanism will go to a retracted status from an extended state, either after a certain amount of delay after the pressure is released.

In a possible implementation form, the jaw muzzle mechanism is attached to a collar.

In a possible implementation form, the jaw muzzle mechanism is attached to a chain/belt that goes around the legs of the animal.

In a possible implementation form, pressure points are used to activate the muzzle mechanism to extend.

In a possible implementation form, upon release of pressure, the extended muzzle mechanism retracts gently.

In a possible implementation form, the mechanism for retraction may be spring controlled in nature.

In a possible implementation form, the mechanism for retraction may be pneumatic in nature.

In a possible implementation form, the jaw muzzle mechanism is firmly attached to a collar, allowing the two mechanisms to operate as one unit.

In a possible implementation form, the jaw muzzle mechanism is securely attached to the collar in a manner which prevents the collar from being rotated around the pet's neck.

In a possible implementation form, the collar is held firmly held in place by usage of a belt running behind the front legs of the animal.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the invention will be explained in more detail with reference to the example embodiments shown in the drawings, in which like references indicate like elements and:

FIG. 1 is a front view of a protective pet guard device incorporating aspects of the disclosed embodiments shown attached to an animal.

FIG. 2 is an approximation of the top view the protective pet guard device in accordance with an embodiment herein.

FIG. 3 is a side view of the protective pet guard device of the disclosed embodiments in an expanded state.

FIG. 4 is a side view of the protective pet guard device in the expanded state. It shows the protective pet guard device attached to a neck belt/ring, which is in turn held in place by a belt that runs behind the hind legs of the dog's body, thus securing it in place.

FIG. 5 is a side view of the protective pet guard device with an associated spring mechanism. The spring mechanism will consist either of a mechanical spring, an electronic motorized mechanism or a pneumatic mechanism that will help expand the protective pet guard device into place as well as help retract the same.

### DETAILED DESCRIPTION OF THE DISCLOSED EMBODIMENTS

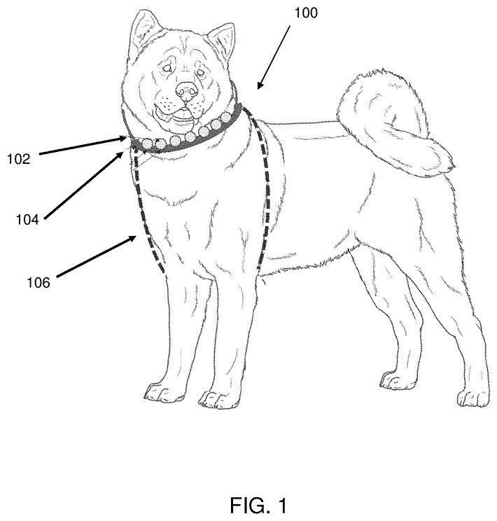

Referring to FIG. 1 a protective pet guard device 100 is illustrated in accordance with the embodiments herein. In this example, the protective pet guard device 100 is shown attached to an animal, such as a dog. In alternate embodiments, the pet guard device 100 can be attached on any suitable animal. The pet guard device 100 is in the retracted position or state as is shown in FIG. 1.

An embodiment of the protective pet guard device 100 comprises or is attached to a collar 102 that goes around the pet's neck, with pressure points or buttons 104. The pressure points or buttons 104 are configured to cause the protective pet guard device 100 to expand. The neck belt/collar 102 is attached to a belt or chain 106 that holds the collar 102 and the protective pet guard device 100 in place on the body of the animal.

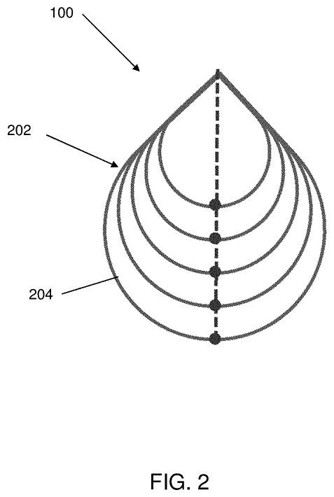

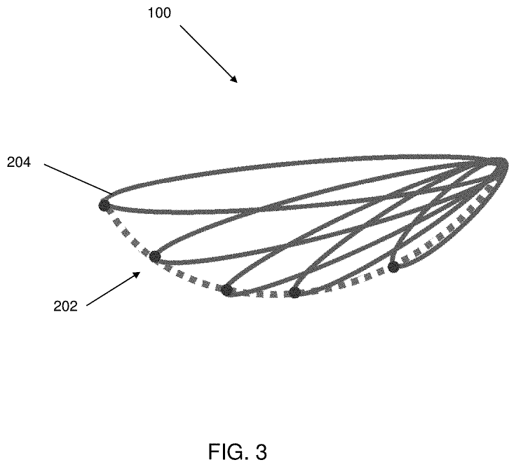

FIGS. 2 and 3 illustrate one embodiment of the pet guard device 100 in an expanded state. As shown in FIGS. 2 and 3, the protective pet guard device 100 of the disclosed embodiments has a plurality of telescopic/retractable elements or layers 202 of elements 204. The elements 204 are configured to extend out in a telescoping fashion when needed to protect the pet from using its mouth to access the injured/surgical area. One end of the elements 204 can be coupled together in a movable or pivotable manner. The elements 204 are configured to move into position between the pet's mouth and the pet body.

The number of layers 202 of elements 204 can depend upon the side of the protective pet guard device 100 as well as the size of the animal on which the device 100 will be used and how far the device 100 should telescope out. In one embodiment, the layers 202 of elements 204 are configured to return to the retracted position when the pet is not moving or turning its head toward the area of the pets body that is desired to be protected.

While the pet will effectively be unable to reach the injured/surgical area with its mouth, the aspects of the disclosed embodiments provide that the pet will be unrestricted in its ability to access items with its mouth directly in front of it, so for example eating, playing with toys will not be restrained. In one embodiment, the telescopic layers 202 of elements 2042 are configured to only extend out to effectively block the pet's mouth when the pet turns its head in or towards a certain direction.

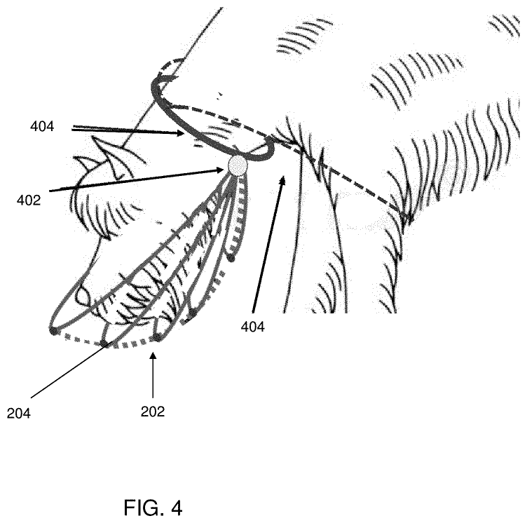

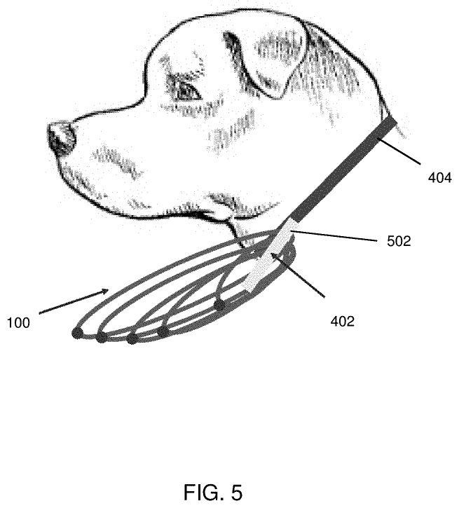

Referring to FIGS. 4 and 5, the retractable layers 202 are configured with or controlled by an activation device 402. In one embodiment, the activation device 402 includes a triggering device, such as a pressure sensor or pressure point. The pressure point or sensor, an example of which is shown as trigger 502 in FIG. 5, when pressed or otherwise activated by the action of the animal bending its head up or down or moving side to side, is configured to cause the retractable layers 202 to extend out telescopically thus preventing the pet from reaching the injured/affected areas with its mouth.

As the layers 202 extend out towards the unretracted position, the layers effectively form a barrier at least around the pet's mouth. In the example of FIG. 4, the layers 202 of elements 204 of the protective pet guard device 100 only extend upwards around the jaw and mouth area of the animal.

In one embodiment, also referring to FIG. 4, the protective pet guard device 100 can be attached or otherwise connected to a neck belt or ring 404. The protective pet guard device 100 can also be attached to a support 406 around the body of the animal. The support 406 can be any suitable support device, such as a belt, that secures the protective pet guard device 100 to the body of the animal. In this example, the support or belt 406 loops around the dog's body behind the front legs.

The activation device 402 may comprise one or more of a spring mechanism, a pivot mechanism similar to a typewriter key, or a pneumatic mechanism or a motorized mechanism that is electronically controlled. The activation device 402 can comprise buttons or other switching mechanisms that are configured to cause the layers 202 to expand out, when the activation device 402 is activated or pressed. As an example, if the animal turns its head to the side and toward its rear, the pressure point(s) 402 can be activated and the layers 202 will expand outward, as shown in the example of FIG. 4.

In one embodiment, the activation mechanism 402 is also configured to cause the layers 202 to auto-retract when the pressure is removed, which will happen for example, when the pet's head/neck is facing forward. In this manner, the layers 202 will move to the expanded or extended state when the animal moves its head in a direction where it should not be. When the head is moved back to an acceptable position, the layers 202 will retract. In this manner, the layers 202 of the protective pet guard device 100 are only in the extended state when required.

Referring again to FIG. 1, the protective pet guard device 100 is attached to a collar 102 that is easily mounted around the pet's neck. The embodiment of the protective pet guard device 100 is most likely a plastic material. In alternate embodiments, the material of the protective pet guard device 100 is any suitable material that will withstand the rigors of an animal and their activities. The protective pet guard device 100 and the collar 102 are attached with through the use of multiple attachments, such as. pins or couplers.

As shown in FIG. 1, the collar 102 is further attached to a belt 106 that is meant to be placed behind the front legs of the animal to hold the collar 102 steadily in place and prevent the collar 102 itself from twisting around the neck. This embodiment may further comprise a hook and loop system that enables a pet leash to be attached to the collar 102 if needed.

The aspects of the disclosed embodiments are directed to a protective pet wear device that includes a telescopic jaw guard. Th guard forms a snug cup along the jaw. The jaw guard itself is attached to a soft collar material along the neck, which effectively holds the telescopic jaw guard in place. An attempt by the pet to move its head in either direction activates pressure points along the neck collar causing the telescopic mechanism to be activated, effectively creating a muzzle along the pet's jaw. The muzzle effectively creates a barrier between the pet's mouth and the bodily area intended to be avoided. The collar is further held in place by an additional belt that is attached to the body, to prevent the collar itself from shifting around.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A pet guard device comprising:
a plurality of layers of movable elements;
an activation mechanism coupled to the layers of movable elements and configured to move the layers of movable elements between a retracted state and an expanded state; and
a triggering device, the triggering device, when activated, being configured to cause the activation device to move the layers of movable elements to the expanded state.

2. The pet guard device according to claim 1, wherein the layers of movable elements are arranged in a telescoping manner.

3. The pet guard device according to claim 1 wherein the triggering device is a pressure activated device.

4. The pet guard device according to claim 3, wherein a release of pressure is configured to cause the activation device to move the layers of movable elements to the retracted state.

5. The pet guard device according to claim 1, further comprising a belt configured to restrain the device to a body of an animal.

6. The pet guard device according to claim 1, wherein an element of the plurality of layers of movable elements has a teardrop shape.

7. The pet guard device according to claim 6, wherein ends of elements of the plurality of movable elements are connected together.

8. The pet guard device according to claim 7 wherein a diameter of a first movable element of the plurality of movable elements is smaller than a diameter of at least one second movable element.

9. The pet guard device according to claim 1, wherein the activation mechanism is a spring loaded device.

10. The pet guard device according to claim 1, wherein the device is configured to be attached to a collar of an animal.
